(19) United States
(12) Patent Application Publication
(10) Pub. No.: US 2026/0330781 A1
(43) Pub. Date: Oct. 22, 2026

(54) INFORMATION PROCESSING APPARATUS CONFIGURED TO CONTROL VIRTUAL OBJECT DISPLAY, METHOD FOR CONTROLLING INFORMATION PROCESSING APPARATUS, SYSTEM, AND NON-TRANSITORY COMPUTER READABLE MEDIUM

(71) Applicant: CANON KABUSHIKI KAISHA, Tokyo (JP)

(72) Inventor: SHINYA OMORI, Tokyo (JP)

(21) Appl. No.: 19/642,394

(22) Filed: Apr. 8, 2026

(30) Foreign Application Priority Data
Apr. 21, 2025 (JP) 2025-069946

(51) Int. Cl. G06T 19/00; G06T 5/50; G06T 5/70; G06T 19/20; H04N 23/63

(52) U.S. Cl. CPC G06T 19/006; G06T 5/50; G06T 5/70; G06T 19/20; H04N 23/632; G06T 2207/20221; G06T 2219/2012; G06T 2219/2016

(57) ABSTRACT

An information processing apparatus according to the present disclosure includes a first acquisition unit configured to acquire a first captured image in accordance with a position or an attitude of a display apparatus, and a display control unit configured to perform control to display, on the display apparatus, a first composite image in which the first captured image and a virtual window based on a live view image from an external image capturing apparatus are combined. In the first composite image, a virtual object displayed outside the virtual window is rendered without being based on a position or an attitude of the external image capturing apparatus and without being based on an imaging parameter of the external image capturing apparatus, and the virtual object displayed inside the virtual window is rendered based on the position or the attitude of the external image capturing apparatus and the imaging parameter.

### BACKGROUND

### Field of the Technology

The present disclosure relates to an information processing apparatus configured to control virtual object display.

### Description of the Related Art

Virtual reality (VR) is known as a technology for experiencing a virtual environment. Further, mixed reality (MR) is known as a technology that seamlessly merges real and virtual environments in real time. As an apparatus for experiencing these technologies, a head-worn device such as a head-mounted display (HMD) is used.

There is a technology that superimposes a virtual object onto a real environment and presents the resulting MR environment combining the real environment and the virtual object to an observer. To capture an image (MR image) including the real environment and the virtual object from a desired angle of view, a screenshot function of an HMD that supports the MR technology is often used. However, in many examples that realize the function, an imaging condition and imaging performance thereof depend on an imaging condition and imaging performance of a background capturing camera of the HMD. Thus, to capture a high-quality MR image without being subject to the constraint, a configuration is required that captures an environment including a real environment and a virtual object while checking an imaging angle of view from a viewpoint of an external image capturing apparatus and a preview image. For example, Japanese Patent Laid-Open No. 2023-89521 describes a technology that reduces unnatural appearance of a composite image by adjusting noise rendering of a virtual object based on sensor information about an image capturing apparatus while superimposing the virtual object onto an image captured by the image capturing apparatus.

### SUMMARY

The conventional technology described in the above-described patent document does not consider a case where an image is captured while a virtual object placed in a real environment is viewed through a head-mounted display (HMD).

The present disclosure is directed to improving user experience in a case where imaging is performed while viewing a virtual object placed in the real environment through an HMD.

According to an aspect of the present disclosure, an information processing apparatus configured to be connected to, or integrated with, a display apparatus worn on a head of a user, includes a processor, and a memory storing a program which, when executed by the processor, causes the information processing apparatus to execute first acquisition processing to acquire a first captured image in accordance with a position or an attitude of the display apparatus, and execute display control processing to perform control to display, on the display apparatus, a first composite image in which the first captured image and a virtual window based on a live view image from an external image capturing apparatus are combined, wherein, in the first composite image, a virtual object displayed outside the virtual window is rendered without being based on a position or an attitude of the external image capturing apparatus and without being based on an imaging parameter of the external image capturing apparatus, and wherein, in the first composite image, the virtual object displayed inside the virtual window is rendered based on the position or the attitude of the external image capturing apparatus and the imaging parameter.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an entire system according to one or more aspects of the present disclosure.

FIG. 2A is a diagram illustrating an example of an external configuration of a digital camera, as viewed from the front, according to one or more aspects of the present disclosure.

FIG. 2B is a diagram illustrating an example of an external configuration of the digital camera, as viewed from the rear, according to one or more of the present disclosure.

FIG. 3 is a diagram illustrating an example of an internal configuration of the digital camera according to one or more aspects of the present disclosure.

FIG. 4 is a diagram illustrating an example of configurations of a head-mounted display (HMD), a personal computer (PC), and a controller according to one or more aspects of the present disclosure.

FIG. 5 is a diagram illustrating an example of a mixed reality (MR) environment that a user wearing the HMD experiences, according to one or more aspects of the present disclosure.

FIG. 6A is a diagram illustrating an example of a screen display of the HMD according to one or more aspects of the present disclosure.

FIG. 6B is a diagram illustrating an example of a screen display of the HMD according to one or more aspects of the present disclosure in a case where a hue of a real environment has been changed.

FIG. 6C is a diagram illustrating an example of a screen display of the HMD according to one or more aspects of the present disclosure in a case where a virtual object having a hue changed to match the changed hue of the real environment is displayed.

FIG. 7 is a flowchart illustrating an example of a process for a live view image in the digital camera according to one or more aspects of the present disclosure.

FIG. 8 is a flowchart illustrating an example of a process in the PC according to one or more aspects of the present disclosure.

### DESCRIPTION OF THE EMBODIMENTS

Each embodiment will be described with reference to the drawings. Identical or equivalent components, members, or processes are assigned the same reference numerals in the drawings, and redundant descriptions may be omitted as appropriate. Further, the components, members, or processes may be omitted in part in the drawings. The following embodiments are not intended to limit the present disclosure, and not all combinations of features described in the present embodiment are necessarily essential to the solution means of the present disclosure. A configuration of the embodiment may be modified or changed as necessary based on specifications or various conditions (such as operating conditions and operation environments) of an apparatus to which the present disclosure is applied.

In the following embodiment, the same reference numerals are assigned to the same components and are used in the description.

### First Embodiment

### Configuration of Information Processing System 1

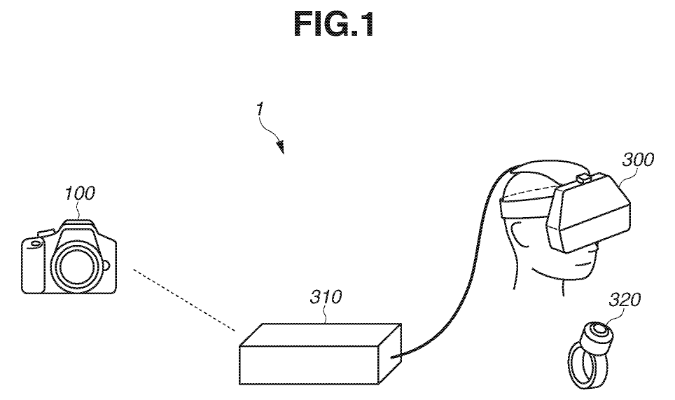

An example of a configuration of an entire system according to an embodiment of the present disclosure will be described with reference to FIG. 1. An information processing system 1 includes a digital camera 100, a head-mounted display (HMD) 300, a personal computer (PC) 310, and a controller 320.

The digital camera 100 is connected to the PC 310 so that the digital camera 100 can perform wired or wireless communication with the PC 310, and transmits and receives various types of data, such as live view image data and captured image data. Although a digital camera as an example of an image capturing apparatus is described herein, this is not intended to be limiting. Any image capturing apparatus capable of realizing a function described below may be employed, such as a smartphone or a tablet terminal. The information processing system 1 is not limited to a system in which the digital camera 100 communicates with the PC 310 and may be a system in which the digital camera 100 communicates with the HMD 300.

The HMD 300 is a head-mounted display apparatus (electronic device) configured to be worn on the head of a user. The HMD 300 displays a composite image being generated by combining a captured image of an area in front of the user captured by the HMD 300 and content such as computer graphics (CG) having a form in accordance with a position or an attitude of the HMD 300.

The PC 310 controls the HMD 300. The PC 310 is connected to the HMD 300 via a wired connection, such as a universal serial bus (USB) cable, or a wireless connection, such as Bluetooth® or Wi-Fi® (Wireless Fidelity). The PC 310 combines a captured image with CG to generate a composite image and transmits the composite image to the HMD 300. The PC 310 receives a live view image or a captured image from the digital camera 100, combines the received image with CG having a form in accordance with the position or attitude of the digital camera 100 to generate a composite image, and transmits the composite image to the HMD 300. Although a PC as an example of an information processing apparatus is described herein, this is not intended to limit the information processing apparatus. For example, the information processing apparatus may be a smartphone or a tablet terminal, and each configuration of the PC 310 may be included in the HMD 300. Although an example in which the PC 310 and the digital camera 100 are wirelessly connected is described in the present embodiment, the PC 310 and the digital camera 100 may be connected via a wired connection.

The controller 320 performs various types of control on the HMD 300. In a case where the PC 310 is in a specific control mode, when a user operation is performed on the controller 320, the HMD 300 is controlled based on the user operation. The controller 320 may have a ring-shaped form configured to be worn on and supported by a finger of the user or a handheld shape configured to be held in the hand, as illustrated in FIG. 1. Further, the controller 320 includes a physical button for performing determination and selection operations on a display. The controller 320 performs wireless communication with the PC 310 using Bluetooth. The information processing system 1 is not limited to a system in which the controller 320 communicates with the PC 310 and may be a system in which the controller 320 communicates with the HMD 300. By moving the controller 320, the user can change an indicated position on the display that corresponds to the movement of the controller 320. The indicated position may be represented as a point or as a virtual ray by connecting the point of the indicated position and the controller 320 using a solid line (line segment) or a broken line. By pressing the physical button, a confirmation or selection operation can be performed on a menu. Although the controller 320 is described as being ring-shaped or handheld, the shape of the controller 320 is not limited to the ring and handheld shapes, and the controller 320 may have any shape configured to be supported by a finger, a hand, or an arm. Further, although the button is described as a physical button, the button may be configured to be operable like a trackpad, a touch panel, a wheel, or a trackball. Further, the button may be operated by sliding, flicking, or touching, as well as pressing. The controller 320 may be worn on at least one of a finger, a hand, and an arm. Further, the controller 320 may be attached to an object held in a hand to acquire position information and attitude information about the attached position from a sensor. Examples of such an object include a tool-shaped object.

### External Configuration of Digital Camera 100

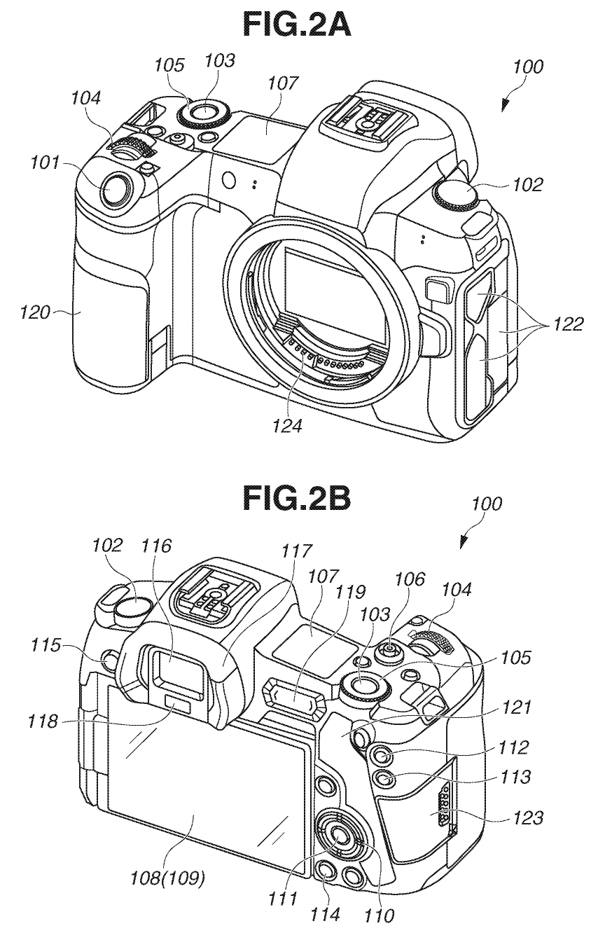

FIGS. 2A and 2B are diagrams illustrating an example of an external configuration of the digital camera 100 (hereinafter, referred to as the camera). FIG. 2A is a perspective view illustrating the camera 100 viewed from the front, and FIG. 2B is a perspective view illustrating the camera 100 viewed from the rear.

The camera 100 includes, on its upper surface, a shutter button 101, a power supply switch 102, a mode selection switch 103, an electronic main dial 104, an electronic sub dial 105, a moving image button 106, and an outside-viewfinder display portion 107.

The shutter button 101 is an operation member for performing image capture preparation or issuing an image capture instruction. The power supply switch 102 is an operation member for switching the camera 100 on or off. The mode selection switch 103 is an operation member for switching various modes. The electronic main dial 104 is a rotary operation member for changing a setting value, such as a shutter speed or an aperture. The electronic sub dial 105 is a rotary operation member for moving a selection frame (cursor), performing image advancement, and other operations. The moving image button 106 is an operation member for issuing an instruction to start or stop capturing (recording) a moving image. The outside-viewfinder display portion 107 displays various setting values, such as the shutter speed and the aperture.

Further, the camera 100 includes, on its rear surface, a display portion 108, a touch panel 109, a direction key 110, a SET button 111, an auto-exposure (AE) lock button 112, a magnification button 113, a reproduction button 114, a menu button 115, and a touch bar 119. Further, the camera 100 includes, on its rear surface, an eyepiece portion 116 and an eyepiece detection portion 118.

The display portion 108 displays an image and various types of information. The touch panel 109 is an operation member configured to detect a touch operation performed on a display surface (touch surface) of the display portion 108. The direction key 110 is an operation member including a key (four-direction key) configured to be pressed in each of upward, downward, leftward, and rightward directions. It is possible to perform an operation based on a pressed position of the direction key 110. The SET button 111 is an operation member configured to be pressed mainly to determine a selected item. The AE lock button 112 is an operation member configured to be pressed to lock an exposure state during an image capture standby state.

The magnification button 113 is an operation member for switching an enlargement mode on or off for a live view display (LV display) in an image capturing mode. In a case where the enlargement mode is on, operating the electronic main dial 104 enlarges or reduces the live view image (LV image). Further, the magnification button 113 is used to enlarge a reproduced image in a reproduction mode or to increase a magnification ratio.

The reproduction button 114 is an operation member for switching between the image capturing mode and the reproduction mode. Pressing the reproduction button 114 during the image capturing mode causes a transition to the reproduction mode and displays the newest image among the images recorded in a recording medium 227, which will be described below, on the display portion 108.

The menu button 115 is an operation member configured to be pressed to display a menu screen for configuring various settings on the display portion 108. The user can intuitively configure various settings using the menu screen displayed on the display portion 108, the direction key 110, and the SET button 111.

The eyepiece portion 116 is a portion at which an eye is positioned with respect to an eyepiece viewfinder 117 (a finder configured to be looked into). The user can view an image displayed on an electronic viewfinder (EVF) 217 located inside, which will be described below, through the eyepiece portion 116.

The eyepiece detection portion 118 is a sensor configured to detect whether an eye of the user is at the eyepiece portion 116.

The touch bar 119 is a linear touch operation member (line touch sensor) configured to receive a touch operation. The touch bar 119 is positioned so that a touch operation can be performed on the touch bar 119 (the touch bar 119 can be touched) with the thumb of the right hand while a grip portion 120 is held with the right hand (with the little, ring, and middle fingers of the right hand) so that the shutter button 101 can be pressed with the index finger of the right hand.

In other words, the touch bar 119 can be operated while an eye of the user is positioned at the eyepiece portion 116 to look into the eyepiece viewfinder 117 and the camera 100 is held so that the shutter button 101 can be pressed at any time (imaging attitude). The touch bar 119 is configured to receive a tap operation (an operation in which the touch bar 119 is touched and then released within a predetermined period of time without movement), a leftward or rightward slide operation (an operation in which the touch bar 119 is touched and then the touched position is moved while touching the touch bar 119), and other operations performed on the touch bar 119. The touch bar 119 is an operation member different from the touch panel 109 and does not include a display function. The touch bar 119 according to the present embodiment functions as a multi-function bar (M-Fn bar) configured to be assigned a function selected from a plurality of functions by the user.

Further, the camera 100 includes the grip portion 120, a thumb rest portion 121, a terminal cover 122, a lid 123, a communication terminal 124, and other components.

The grip portion 120 is a holding portion formed in a shape that is easily gripped with the right hand while the camera 100 is held by the user. The shutter button 101 and the electronic main dial 104 are positioned so that shutter button 101 and the electronic main dial 104 can be operated with the index finger of the right hand in a state where the camera 100 is held by gripping the grip portion 120 with the little, ring, and middle fingers of the right hand. Further, the electronic sub dial 105 and the touch bar 119 are positioned so that the electronic sub dial 105 and the touch bar 119 can be operated with the thumb of the right hand in a similar state.

The thumb rest portion 121 (thumb standby position) is a grip portion positioned so that the thumb of the right hand gripping the grip portion 120 can easily rest on the grip portion in a state where none of the operation members provided on the rear side of the camera 100 is operated. The thumb rest portion 121 includes a rubber member or the like to enhance holding force (grip feel).

The terminal cover 122 protects a connector configured to connect the camera 100 to an external device, such as a connection cable. The lid 123 blocks a slot for storing the recording medium 227, which will be described below, thereby protecting the recording medium 227 and the slot. The communication terminal 124 is a terminal for communication between the camera 100 and a lens unit 200 configured to be detachable, which will be described below.

### Internal Configuration of Digital Camera 100 (Camera 100)

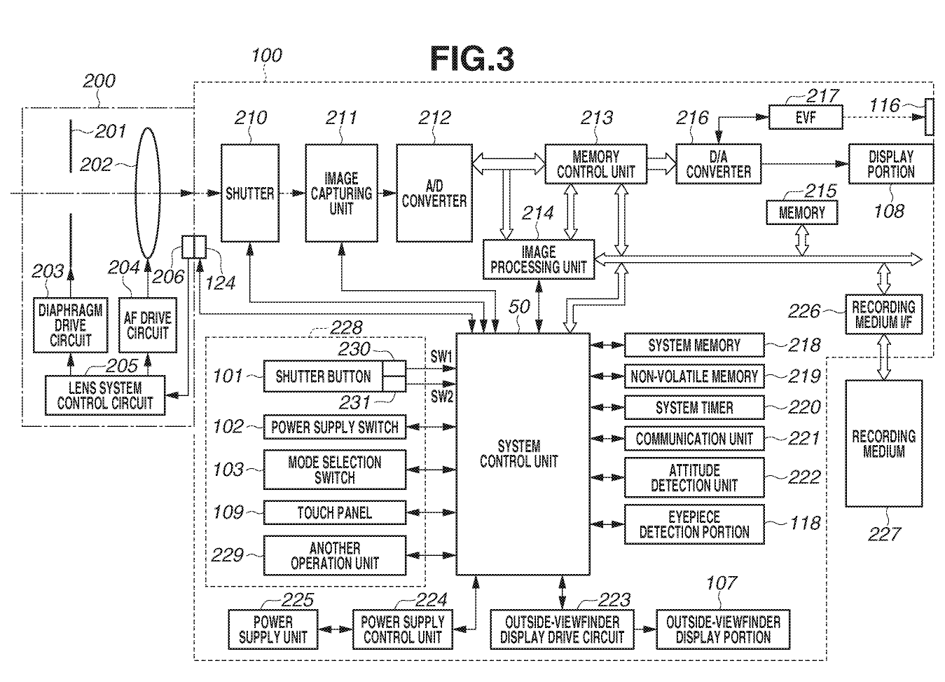

FIG. 3 is a diagram illustrating an example of an internal configuration of the camera 100. Components identical to those in FIGS. 2A and 2B are assigned the same reference numerals, and descriptions thereof may be omitted as appropriate. The lens unit 200 is attached to the camera 100.

First, the lens unit 200 will be described. The lens unit 200 is a type of interchangeable lens attachable to and detachable from the camera 100. The lens unit 200 is a single lens and is an example of an ordinary lens. The lens unit 200 includes a diaphragm 201, a lens 202, a diaphragm drive circuit 203, an autofocus (AF) drive circuit 204, a lens system control circuit 205, a communication terminal 206, and other components.

The diaphragm 201 is configured to adjust an aperture diameter. The lens 202 includes a plurality of lenses. The diaphragm drive circuit 203 adjusts the amount of light by controlling the aperture diameter of the diaphragm 201. The AF drive circuit 204 drives the lens 202 to adjust focus.

The lens system control circuit 205 controls the diaphragm drive circuit 203, the AF drive circuit 204, and other components based on an instruction from a system control unit 50, which will be described below. The lens system control circuit 205 controls the diaphragm 201 via the diaphragm drive circuit 203 and displaces the position of the lens 202 via the AF drive circuit 204 to adjust focus. The lens system control circuit 205 is configured to communicate with the camera 100. Specifically, communication is performed via the communication terminal 206 of the lens unit 200 and the communication terminal 124 of the camera 100. The communication terminal 206 is a terminal for communication between the lens unit 200 and the camera 100.

Next, the camera 100 will be described.

The camera 100 includes a shutter 210, an image capturing unit 211, an analog-to-digital (A/D) converter 212, a memory control unit 213, an image processing unit 214, a memory 215, a digital-to-analog (D/A) converter 216, the EVF 217, the display portion 108, and the system control unit 50.

The shutter 210 is a focal plane shutter configured to freely control an exposure time of the image capturing unit 211 based on an instruction from the system control unit 50. The image capturing unit 211 is an image capture element (image sensor) configured to convert an optical image into an electrical signal and including a charge-coupled device (CCD) image sensor, a complementary metal-oxide-semiconductor (CMOS) image sensor, or the like. The image capturing unit 211 may include an imaging-plane phase-difference sensor configured to output information about an amount of defocus to the system control unit 50. The A/D converter 212 converts an analog signal output from the image capturing unit 211 into a digital signal.

The image processing unit 214 performs predetermined processing (pixel interpolation, resizing processing, such as reduction, color conversion processing, and other processing) on data from the A/D converter 212 or data from the memory control unit 213.

Further, the image processing unit 214 performs predetermined computation processing using captured image data, and the system control unit 50 performs exposure control and distance measurement control based on the obtained computation result. By this processing, through-the-lens (TTL) AF processing, AE processing, electronic flash (EF, pre-flash) processing, and other processing are performed. Furthermore, the image processing unit 214 performs predetermined computation processing using the captured image data and performs TTL automatic white balance (AWB) processing based on the obtained computation result. Image data from the A/D converter 212 is written to the memory 215 via the image processing unit 214 and the memory control unit 213. Alternatively, the image data from the A/D converter 212 is written to the memory 215 via the memory control unit 213 without using the image processing unit 214.

The memory 215 stores image data captured by the image capturing unit 211 and converted into digital data by the A/D converter 212 and image data to be displayed on the display portion 108 or the EVF 217. The memory 215 has sufficient storage capacity to store a predetermined number of still images and a predetermined duration of moving images and audio. Further, the memory 215 also functions as a memory (video memory) for image display.

The D/A converter 216 converts data for image display stored in the memory 215 into an analog signal and feeds the analog signal to the display portion 108 or the EVF 217. Accordingly, the image data for display written to the memory 215 is displayed on the display portion 108 or the EVF 217 via the D/A converter 216. The display portion 108 or the EVF 217 performs display based on the analog signal from the D/A converter 216. For example, the display portion 108 and the EVF 217 are displays such as a liquid crystal display (LCD) or an organic electroluminescent (organic EL) display. The digital signal converted from the analog signal by the A/D converter 212 and accumulated in the memory 215 is converted into an analog signal by the D/A converter 216, and the analog signal is sequentially transferred to the display portion 108 or the EVF 217 and displayed, thereby providing live-view display.

The system control unit 50 is a control unit including at least one processor and/or at least one circuit. In other words, the system control unit 50 may be a processor, a circuit, or a combination of a processor and a circuit. The system control unit 50 controls the entire camera 100. The system control unit 50 executes a program recorded in a non-volatile memory 219, thereby realizing each process illustrated in a flowchart described below. Further, the system control unit 50 also performs display control by controlling the memory 215, the D/A converter 216, the display portion 108, the EVF 217, and other components.

Further, the camera 100 includes a system memory 218, the non-volatile memory 219, a system timer 220, a communication unit 221, an attitude detection unit 222, and the eyepiece detection portion 118.

For example, the system memory 218 uses a random access memory (RAM). The system memory 218 is a recording unit into which a constant and/or a variable used by the system control unit 50 for operation, a program read from the non-volatile memory 219, and the like are loaded.

The non-volatile memory 219 is an electrically erasable programmable memory (recording unit). For example, an electrically erasable programmable ROM (EEPROM) is used. The constant and/or the variable used by the system control unit 50 for operation, the program, and the like are recorded in the non-volatile memory 219. The program herein refers to a program for executing a flowchart described below.

The system timer 220 is a time measurement unit configured to measure the time used for various types of control and the time of a built-in clock. The communication unit 221 transmits and receives an image signal and an audio signal to and from an external device connected wirelessly or via a wired cable.

The communication unit 221 is also configured to connect to a wireless local area network (wireless LAN) and the Internet. Further, the communication unit 221 is also configured to communicate with the external device using Bluetooth® or Bluetooth® Low Energy. The communication unit 221 is configured to transmit an image (including a live image) captured by the image capturing unit 211 and an image recorded in the recording medium 227, and receive image data and various other types of information from the external device.

The attitude detection unit 222 detects an attitude of the camera 100 with respect to the direction of gravity. It is possible to determine whether an image captured by the image capturing unit 211 is an image captured with the camera 100 held horizontally or an image captured with the camera 100 held vertically, based on the attitude detected by the attitude detection unit 222. The system control unit 50 may add orientation information based on the attitude detected by the attitude detection unit 222 to an image file of the image captured by the image capturing unit 211 or may rotate the image and record the rotated image. For example, the attitude detection unit 222 may use an acceleration sensor, a gyro sensor, and the like. It is also possible to detect movement of the camera 100 (for example, whether the camera 100 is panned, tilted, lifted, or held still) using the attitude detection unit 222.

The eyepiece detection portion 118 is configured to detect an object approaching the eyepiece portion 116 of the eyepiece viewfinder 117 including the EVF 217. For example, the eyepiece detection portion 118 may use an infrared proximity sensor. In a case where an object approaches, infrared light emitted from a light-emitting unit of the eyepiece detection portion 118 is reflected by an object and then received by a light-receiving unit of the infrared proximity sensor. The distance from the eyepiece portion 116 to the object can be determined based on the amount of received infrared light. As described above, the eyepiece detection portion 118 performs eyepiece detection to detect the proximity of the object to the eyepiece portion 116. The eyepiece detection portion 118 is an eyepiece detection sensor configured to detect approach of an eye (object) (proximity of the eye) to the eyepiece portion 116 of the eyepiece viewfinder 117 and withdrawal of the eye (object) (separation of the eye) from the eyepiece portion 116. In a case where an object approaching the eyepiece portion 116 within a predetermined distance is detected in a non-proximity state (non-approach state), the proximity of the eye is detected. On the other hand, in a case where the object detected as approaching is separated from the eyepiece portion 116 by at least a predetermined distance in a proximity state (approach state), the separation of the eye is detected. A threshold for detecting the proximity of the eye and a threshold for detecting the separation of the eye may be set to different values, for example, by applying hysteresis. Further, after the proximity of the eye is detected, the proximity state continues until the separation of the eye is detected. After the separation of the eye is detected, the non-proximity state continues until the proximity of the eye is detected.

The system control unit 50 switches the display portion 108 and the EVF 217 between a display state and a non-display state based on the state detected by the eyepiece detection portion 118. Specifically, in a case where it is at least in the image capture standby state and a display destination switching setting is set to automatic switching, while the eye is not in proximity, the display portion 108 is set as the display destination and is set to the display state, and the EVF 217 is set to the non-display state. Further, while the eye is in proximity, the EVF 217 is set as the display destination and is set to the display state, and the display portion 108 is set to the non-display state. The eyepiece detection portion 118 is not limited to the infrared proximity sensor, and a different sensor configured to detect a state regarded as the eye being in proximity may be used.

Further, the camera 100 includes the outside-viewfinder display portion 107, an outside-viewfinder display drive circuit 223, a power supply control unit 224, a power supply unit 225, a recording medium interface (recording medium I/F) 226, an operation unit 228, and other components.

The outside-viewfinder display portion 107 displays various setting values of the camera 100, such as the shutter speed and the aperture, via the outside-viewfinder display drive circuit 223.

The power supply control unit 224 includes a battery detection circuit, a direct current (DC)-DC converter, a switch circuit configured to switch a block to be energized, and other components, and detects whether a battery is attached and, if so, detects a type of the battery, a remaining battery level, and the like. Further, the power supply control unit 224 controls the DC-DC converter based on the detection result and an instruction from the system control unit 50 and supplies a required voltage to each component including the recording medium 227 for a required period of time.

The power supply unit 225 includes primary batteries, such as an alkaline battery and a lithium battery, secondary batteries, such as a nickel-cadmium (NiCd) battery, a nickel-metal hydride (NiMH) battery, and a lithium-ion battery, an alternating current (AC) adapter, and other components. The recording medium I/F 226 is an interface to the recording medium 227, such as a memory card or a hard disk. The recording medium 227 is a memory card or the like for recording a captured image, and is a recording unit including a semiconductor memory, a magnetic disk, and other components. The recording medium 227 may be configured to be removable or may be built in.

The operation unit 228 is an input unit configured to receive an operation from the user (user operation) and functions as a reception unit used to input various instructions to the system control unit 50. The operation unit 228 includes the shutter button 101, the power supply switch 102, the mode selection switch 103, the touch panel 109, another operation unit 229, and other components.

The other operation unit 229 includes the electronic main dial 104, the electronic sub dial 105, the moving image button 106, the direction key 110, the SET button 111, the AE lock button 112, the magnification button 113, the reproduction button 114, the menu button 115, the touch bar 119, and other components.

The shutter button 101 includes a first shutter switch 230 and a second shutter switch 231.

The first shutter switch 230 is turned when the shutter button 101 is partially operated, i.e., when the shutter button 101 is half-pressed (imaging preparation instruction), and generates a first shutter switch signal SW1. The system control unit 50 starts imaging preparation processing, such as AF processing, AE processing, AWB processing, and EF processing, based on the first shutter switch signal SW1.

The second shutter switch 231 is turned on when the shutter button 101 is fully operated, i.e., when the shutter button 101 is fully pressed (imaging instruction), and generates a second shutter switch signal SW2. The system control unit 50 starts an imaging process in which a signal is read from the image capturing unit 211, an image file including a captured image is generated, and the image file is written to the recording medium 227, based on the second shutter switch signal SW2.

The mode selection switch 103 switches an operation mode of the system control unit 50 to the still image capturing mode, the moving image capturing mode, the reproduction mode, or another mode. The still image capturing mode includes an auto image capturing mode, an auto scene determination mode, a manual mode, an aperture priority mode (Av mode), a shutter speed priority mode (Tv mode), and a program AE mode (P mode). Further, various scene modes in which different imaging settings are applied depending on the imaging scene, a custom mode, and the like are also included. The user can switch directly to one of the image capturing modes described above using the mode selection switch 103. Alternatively, the user may first switch to an image capturing mode list screen using the mode selection switch 103 and then selectively switch to one of the plurality of displayed modes using the operation unit 228. Similarly, the moving image capturing mode may include a plurality of modes.

The touch panel 109 is a touch sensor configured to detect various touch operations on a display surface of the display portion 108 (an operation surface of the touch panel 109). The touch panel 109 and the display portion 108 may be integrated. For example, the touch panel 109 is mounted on an upper layer of the display surface of the display portion 108 so that light transmittance does not interfere with the display of the display portion 108. Then, input coordinates on the touch panel 109 are associated with display coordinates on the display surface of the display portion 108, thereby configuring a graphical user interface (GUI) to allow the user to seemingly directly interact with the screen displayed on the display portion 108. The touch panel 109 may employ any method, such as a resistive, capacitive, surface acoustic wave, infrared, electromagnetic induction, optical imaging, or optical sensor method.

There is a method in which a touch is detected in a case where the touch panel 109 is touched, and there is another method in which a touch is detected in a case where a finger or a stylus pen approaches the touch panel 109. Either method may be employed.

The system control unit 50 is configured to detect the following operations and states of the touch panel 109.

A finger or a stylus pen not previously in contact with the touch panel 109 initiates a touch on the touch panel 109, i.e., a touch begins (hereinafter, referred to as "touch-down").

A state in which the touch panel 109 is touched by the finger or the stylus pen (hereinafter, referred to as "touch-on").

The finger or the stylus pen moves while touching the touch panel 109 (hereinafter, referred to as "touch-move").

The finger or the stylus pen touching the touch panel 109 is removed (released) from the touch panel 109, i.e., the touch is terminated (hereinafter, referred to as "touch-up").

A state in which the touch panel 109 is not being touched (hereinafter, referred to as "touch-off").

In a case where a touch-down is detected, a touch-on is simultaneously detected. Normally, the touch-on continues to be detected after the touch-down unless a touch-up is detected. Similarly, in a case where a touch-move is detected, a touch-on is simultaneously detected. Even in a case where a touch-on is detected, if the touched position does not move, no touch-move is detected. After a touch-up is detected for all touching fingers or stylus pens, a touch-off occurs.

The foregoing operations and states and the position coordinates on the touch panel 109 touched by the finger or the stylus pen are notified to the system control unit 50 via an internal bus. The system control unit 50 determines the type of operation (touch operation) performed on the touch panel 109 based on the notified information. For touch-move, a moving direction of the finger or the stylus pen moving on the touch panel 109 can also be determined for each vertical component and each horizontal component based on a change in the position coordinates. In a case where a touch-move of a predetermined distance or greater is detected, it is determined that a slide operation has been performed. A flick is an operation in which a finger is quickly moved for a predetermined distance while touching the touch panel 109 and then released. In other words, the flick is an operation in which a finger is quickly flicked across the touch panel 109. In a case where a touch-move of a predetermined distance or greater at a predetermined velocity or greater is detected followed by detection of a touch-up, it is determined that a flick has been performed (it can be determined that a flick has been performed following a slide operation). Further, a touch operation in which a plurality of points (for example, two points) is simultaneously touched (multi-touch) and the touched positions are moved toward each other is referred to as pinch-in, and a touch operation in which the touched positions are moved away from each other is referred to as pinch-out. The pinch-out and the pinch-in are collectively referred to as a pinch operation (or simply "pinch").

### Configuration of HMD 300

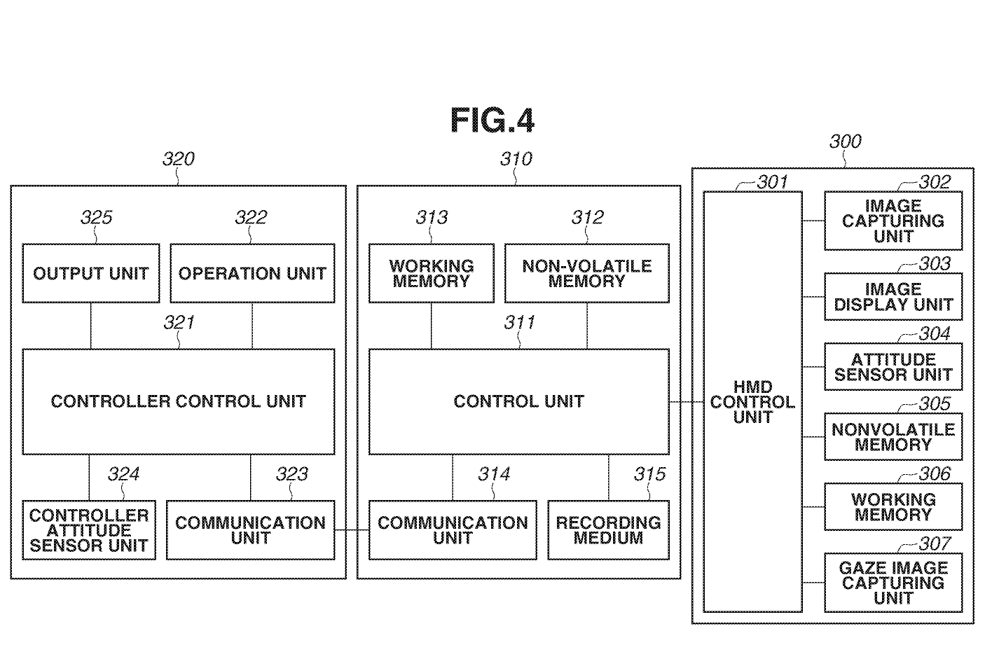

An example of a configuration of the HMD 300 according to an embodiment of the present disclosure will be described with reference to FIG. 4. The HMD 300 includes an HMD control unit 301, an image capturing unit 302, an image display unit 303, an attitude sensor unit 304, a non-volatile memory 305, a working memory 306, and a gaze image capturing unit 307.

The HMD control unit 301 is a CPU configured to control each component of the HMD 300. Upon acquisition of a composite image (an image generated by combining an image of a space in front of the user captured by the image capturing unit 302 with CG) from the PC 310, the HMD control unit 301 displays the composite image on the image display unit 303. Instead of having the HMD control unit 301 control the entire apparatus, a plurality of pieces of hardware may control the entire apparatus by sharing processing tasks.

The image capturing unit 302 includes two cameras (image capturing apparatuses). The two cameras are configured to capture an image that is to be combined with a virtual environment image and is used to generate position or attitude information, and include a left-eye image capturing unit and a right-eye image capturing unit. The left-eye image capturing unit captures a moving image of a real environment corresponding to the left eye of the user wearing the HMD 300, and outputs an image (captured image) of each frame of the moving image. The right-eye image capturing unit captures a moving image of a real environment corresponding to the right eye of the user wearing the HMD 300, and outputs an image (captured image) of each frame of the moving image. In other words, the image capturing unit 302 acquires captured images as stereo images with parallax substantially corresponding to the positions of the left and right eyes of the user wearing the HMD 300. Further, it is possible to acquire distance information from the two cameras to a subject as range information by performing distance measurement using a stereo camera. For an HMD for a mixed reality (MR) system, a central optical axis of an image capturing range of the image capturing unit 302 can be configured to substantially correspond to a gaze direction of the user wearing the HMD.

Each of the left-eye image capturing unit and the right-eye image capturing unit includes an optical system and an image capturing device. Light incident from an external environment enters the image capturing device via the optical system, and the image capturing device outputs an image corresponding to the incident light as a captured image. The images of the subject (a scene in front of the user) captured by the two cameras are output to the PC 310 and the HMD control unit 301. The image capturing unit 302 may capture a moving image and output the moving image instead of captured images. The two cameras are not intended to be limiting, and a plurality of cameras may be used for each eye, or a camera for capturing an image to be used to generate a virtual environment image and another camera for capturing an image to be used to generate position or attitude information may be included.

The image display unit 303 displays a composite image. The image display unit 303 includes a liquid crystal panel, an organic EL panel, or the like. In a state in which the HMD 300 is worn by the user, the image display unit 303 is positioned in front of each eye of the user. The image display unit 303 may use a device using a semi-transmissive half mirror. In this case, for example, the image display unit 303 may display an image using a technology commonly referred to as augmented reality (AR) so that the CG appears to be superimposed directly on the real environment viewed through the half mirror. Further, the image display unit 303 may display an image of a fully virtual environment using a technology commonly referred to as virtual reality (VR) without using a captured image.

The attitude sensor unit 304 acquires attitude (and position) information about the HMD 300. The attitude sensor unit 304 may acquire attitude information about the user (the user wearing the HMD 300) corresponding to the attitude (and position) of the HMD 300. The attitude sensor unit 304 includes an inertial measurement unit (IMU) including an acceleration sensor, an angular acceleration sensor, and a geomagnetic sensor. The attitude sensor unit 304 is used when attitude information about the user is acquired, and the HMD control unit 301 outputs the attitude information about the user to the PC 310. The attitude information may be acquired from one or more of a magnetic sensor (including a geomagnetic sensor), an ultrasonic sensor, an acceleration sensor, and an angular velocity sensor.

The HMD control unit 301 estimates a position or attitude of each joint node of the hands and fingers of the user based on images captured by the two cameras of the image capturing unit 302. The joint nodes include a feature point of a region, such as a finger joint, a fingertip, the back (palm) of the hand, and an arm. Each joint node represents a coordinate position, and an attitude is estimated from information about the plurality of joint nodes. To estimate positions or attitudes of a hand and each joint node of the hand, for example, a publicly-known machine learning-based object recognition or pose estimation method using a convolutional neural network may be used. Further, depth position information about each joint node of the hand may be obtained, for example, by calculating the distance from the image capturing unit 302 to the joint node by triangulation of stereo-matched images captured by the two cameras of the image capturing unit 302. Estimated coordinate information about each joint node of the hand is output from the HMD control unit 301 to the PC 310.

The non-volatile memory 305 is an electrically erasable programmable memory and stores a program to be executed by a control unit 311, which will be described below, and the like. The working memory 306 is used as a buffer memory configured to temporarily store image data captured by the image capturing unit 302, an image display memory for the image display unit 303, a work area for the HMD control unit 301, and the like.

The gaze image capturing unit 307 is a camera configured to acquire an image to detect a gaze of the user and is attached to the inside of the HMD 300 to capture the eyes of the user wearing the HMD 300. An image of the subject (the eye of the user) captured by the camera is output to the control unit 311 of the PC 310 via the HMD control unit 301. The control unit 311 detects the gaze of the user wearing the HMD 300 from the image captured by the gaze image capturing unit 307 and determines the portion of the image display unit 303 gazed at by the user.

### Internal Configuration of PC 310

An internal configuration of the PC 310 according to an embodiment of the present disclosure will be described with reference to FIG. 4. The PC 310 includes the control unit 311, a non-volatile memory 312, a working memory 313, a communication unit 314, and a recording medium 315.

The control unit 311 is a CPU configured to control each component of the PC 310 based on an input signal and a program, which will be described below. Instead of having the control unit 311 control the entire apparatus, a plurality of pieces of hardware may control the entire apparatus by sharing processing tasks. The control unit 311 receives an image (captured image) acquired by the image capturing unit 302 and attitude information acquired by the attitude sensor unit 304 from the HMD 300. The control unit 311 performs image processing on the captured image to cancel aberrations introduced by the optical system of the image capturing unit 302 and an optical system of the image display unit 303. Then, the control unit 311 combines the captured image with predetermined CG to generate a composite image. The control unit 311 transmits the composite image to the HMD control unit 301 of the HMD 300.

Further, the control unit 311 calculates the number of controllers included in the captured image. Further, the control unit 311 performs processing to recognize the position at which each controller is attached, using information acquired via the communication unit 314. Then, the control unit 311 performs control to change details of an operation in response to input information of each controller for each controller based on the recognition results.

The control unit 311 controls the position, orientation, and size of the CG of the composite image based on information (range information and attitude information) acquired by the HMD 300. For example, in a case where a virtual object represented by CG is placed near a specific object, which exists in the real environment, in the environment represented by the composite image, the control unit 311 increases the size of the virtual object (CG) as the distance between the specific object and the image capturing unit 302 decreases. Controlling the position, orientation, and size of the CG as described above enables the control unit 311 to generate a composite image in which the object represented by CG, which is not placed in the real environment, appears as through the object is placed in the real environment.

Further, the control unit 311 receives information estimated by the HMD control unit 301 of the HMD 300 and temporarily stores the information in the working memory 313.

Further, the control unit 311 receives position or attitude change information about the controller 320 from a communication unit 323 of the controller 320 via the communication unit 314. The control unit 311 displays an indicated position superimposed on the composite image based on the position or attitude change information about the controller 320. The control unit 311 may display the indicated position superimposed on the composite image based on the position and attitude change information about the controller 320.

Further, the control unit 311 functions as a reception unit configured to receive various operations from the digital camera 100.

The non-volatile memory 312 is an electrically erasable programmable memory and stores a program to be executed by the control unit 311, which will be described below, and information, such as the CG. The control unit 311 is configured to switch the CG read from the non-volatile memory 312 (i.e., the CG used to generate the composite image).

The working memory 313 is used as a buffer memory for temporarily storing image data captured by the image capturing unit 302 and time-series information about the estimated coordinate position of each joint node of the hand, an image display memory for the image display unit 303, a work area for the control unit 311, and the like.

Further, the hand and joint estimation may be performed by the PC 310. In this case, after the captured image is output from the image capturing unit 302 to the PC 310, the control unit 311 of the PC 310 estimates the position or attitude of each joint node of the hand, processes the image using the information, and outputs the processed image to the HMD 300. The control unit 311 may estimate the position and attitude of each joint node of the hand, process the image using the information, and output the processed image to the HMD 300.

### Internal Configuration of Controller

An internal configuration of the controller 320 according to an embodiment of the present disclosure will be described with reference to FIG. 4. The controller 320 includes a controller control unit 321, an operation unit 322, the communication unit 323, and a controller attitude sensor unit 324.

The controller control unit 321 is a CPU configured to control each component of the controller 320.

Instead of having the controller control unit 321 control the entire apparatus, a plurality of pieces of hardware may control the entire apparatus by sharing processing tasks.

The operation unit 322 includes a button. The operation unit 322 detects whether the button has been operated, and transmits the detection information to the PC 310 via the communication unit 323. The operation unit 322 may include a plurality of input formats.

The communication unit 323 performs wireless communication with the PC 310 using Bluetooth. In a case where there is a plurality of controllers, each controller performs wireless communication with the PC 310 using Bluetooth.

The controller attitude sensor unit 324 includes an IMU including an acceleration sensor, an angular acceleration sensor, and a geomagnetic sensor. The IMU detects a change in position or attitude of the controller 320. The detected position and attitude change information is communicated from the communication unit 323 to the PC 310 via the controller control unit 321.

An output unit 325 includes a light-emitting diode (LED) light source, a speaker, a vibration element, and other components.

### Example of MR Environment

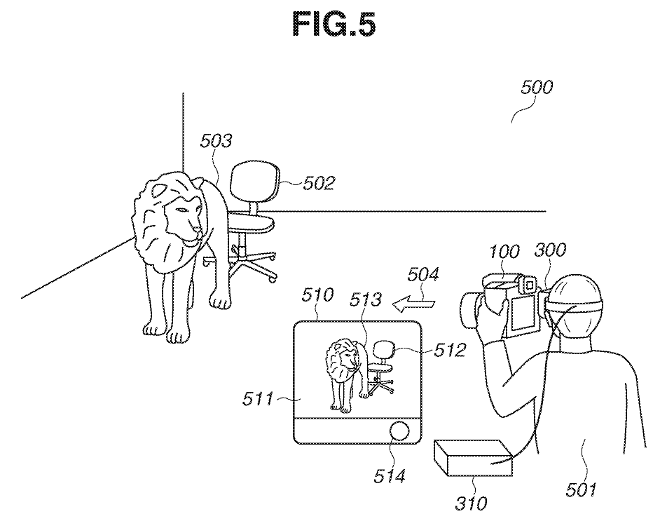

An example of an MR environment experienced by the user according to an embodiment of the present disclosure will be described with reference to FIG. 5. An MR environment viewed by a user 501 will be described herein. Specifically, a case is considered in which a virtual object 503 and a virtual window 510, which will be described below, are not visible to a third party not wearing the HMD 300 while the user 501 wearing the HMD 300 is viewing the virtual object 503 and the virtual window 510. In an MR environment 500, the user 501, the HMD 300 worn by the user 501, the PC 310 communicating with the HMD 300, and the digital camera 100 communicating with the PC 310 exist. Further, a real object 502, the virtual object 503, and the virtual window 510 are displayed. The virtual window 510 displays a live view image 511 captured by the image capturing unit 211 of the digital camera 100, a real object 512, a virtual object 513 having a form in accordance with the position or attitude of the digital camera 100, and an operation member 514. Further, an arrow 504 indicates an image capture direction of the image capturing unit 302 of the HMD 300 worn by the user 501 and an image capture direction of the image capturing unit 211 of the digital camera 100.

### Example of Screen Display of HMD 300

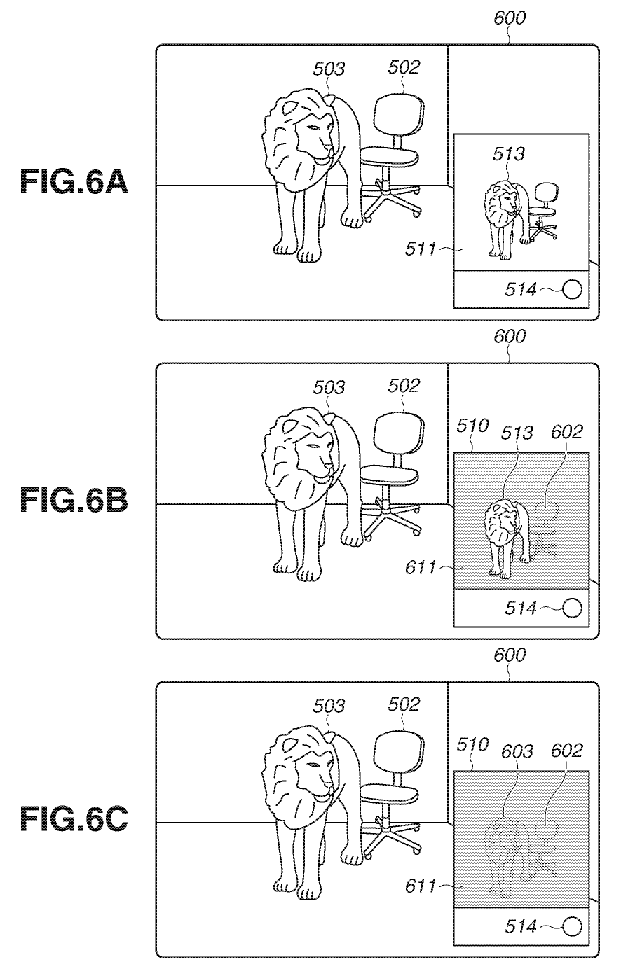

An example of a screen display of the image display unit 303 of the HMD 300 according to an embodiment of the present disclosure will be described with reference to FIGS. 6A, 6B, and 6C.

The screen display 600 in FIG. 6A illustrates an example of a screen display of the image display unit 303 of the HMD 300 in a case where the image capturing unit 302 of the HMD 300 worn by the user 501 captures an image in the direction of the arrow 504 in FIG. 5. The screen display 600 displays the real object 502, the virtual object 503, and the virtual window 510. Further, the virtual window 510 displays the live view image 511 captured by the image capturing unit 211 of the digital camera 100, the virtual object 513 having a form in accordance with the position or attitude of the digital camera 100, and the operation member 514. The operation member 514 may issue an image capture instruction, an imaging parameter change request, or the like to the digital camera 100. The virtual object 503 and the virtual window 510 are displayed to have an appropriate position or attitude in a case where the image capturing unit 302 of the HMD 300 worn by the user 501 captures an image in the direction of the arrow 504 in FIG. 5. Similarly, the virtual object 513 is displayed in the virtual window 510 to have an appropriate position or attitude in a case where the image capturing unit 211 of the digital camera 100 captures an image in the direction of the arrow 504 in FIG. 5. While an example in which the virtual window 510 is placed to appear to virtually exist at a three-dimensional position or attitude in the environment as in the MR environment 500 illustrated in FIG. 5 is described in the present embodiment, this is not intended to be limiting. For example, the virtual window 510 may be configured to be placed at a two-dimensional position on a display region of the screen display 600.

The screen display 600 in FIG. 6B illustrates an example of a screen display of the image display unit 303 of the HMD 300 in a case where the imaging parameter of the digital camera 100, such as the hue, is changed in step S711, which will be described below. Further, a live view image 611 captured by the image capturing unit 211 of the digital camera 100 displays "a background and a real object 602" to which the hue changed by the imaging parameter change has been applied. At this time, the hue of the virtual object 513 remains unchanged.

The screen display 600 in FIG. 6C illustrates an example of a screen display of the image display unit 303 of the HMD 300 in a case where a virtual object 603 having a hue changed to match the changed imaging parameter of the digital camera 100, such as the hue, is displayed. Further, the live view image 611 captured by the image capturing unit 211 of the digital camera 100 displays "the background, the real object 602, and the virtual object 603" to which the hue changed by the imaging parameter change has been applied. Although the "hue" is described as an example of the imaging parameter in the present embodiment, any imaging parameter of the digital camera 100 is applicable, such as the "aperture value", "International Organization for Standardization (ISO) speed rating", "shutter speed", or "acceleration information".

In other words, in FIG. 6C, the virtual object 603 displayed inside the virtual window 510 is rendered based on the imaging parameter of the digital camera 100. Further, the virtual object 603 is rendered in an orientation as viewed from the digital camera 100 based on the position or attitude of the digital camera 100. Further, in FIG. 6C, the imaging parameter of the digital camera 100 is not applied to the virtual object 503 displayed outside the virtual window 510, and it is not considered that the virtual object 503 is rendered based on the imaging parameter of the digital camera 100. Since the virtual object 503 is rendered in an orientation as viewed from the HMD 300, the virtual object 503 is rendered not based on the position or attitude of the digital camera 100 but based on the position or attitude of the HMD 300.

### Example of Processing Flow for Live View Image in Digital Camera 100

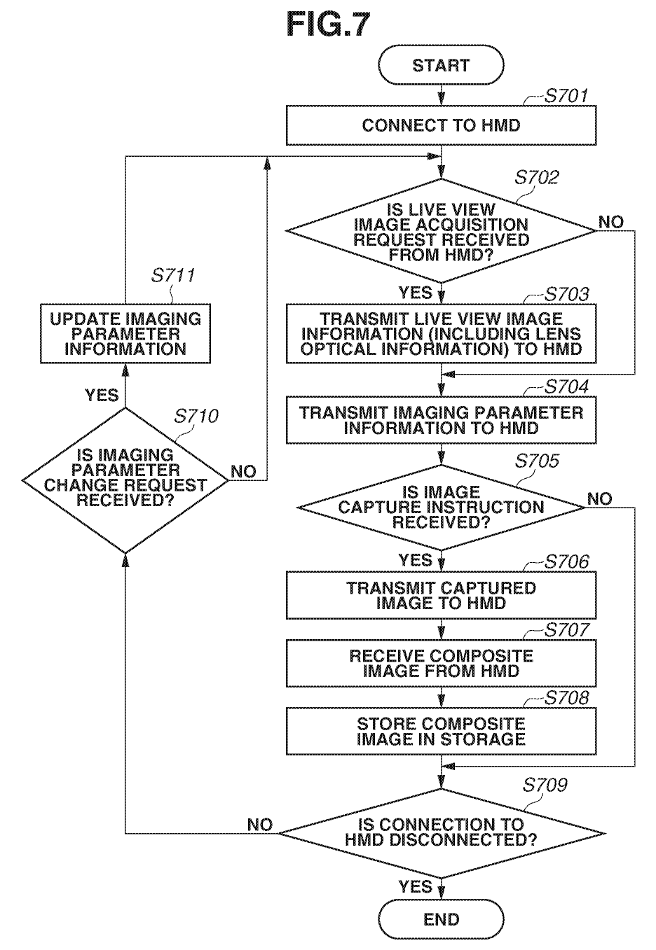

An example of a processing flow for a live view image in the digital camera 100 according to an embodiment of the present disclosure will be described with reference to FIG. 7.

The process in FIG. 7 is realized by the system control unit 50 of the digital camera 100 by loading a program recorded in the non-volatile memory 219 onto the system memory 218 and executing the loaded program. The process in FIG. 7 is performed repeatedly, for example, at a predetermined frequency (such as 60 Hz or 120 Hz).

Further, the flowchart is started in a case where an operation to connect to the HMD 300 is performed. The flowchart is based on a case where the digital camera 100 connects to the HMD 300 via the PC 310.

In step S701, the system control unit 50 controls the communication unit 221 and connects to the PC 310 so that the system control unit 50 can communicate with the PC 310, and the processing proceeds to step S702. The connection method at this time is not restricted, and either wireless or wired communication may be used. In a case where the system control unit 50 connects to the HMD 300 without using the PC 310, the connection may be established so that the system control unit 50 can communicate with the HMD 300 instead of the PC 310.

In step S702, the system control unit 50 determines whether a live view image acquisition request is received from the PC 310. Then, in a case where the system control unit 50 determines that a live view image acquisition request is received (YES in step S702), the processing proceeds to step S703. On the other hand, in a case where the system control unit 50 determines that no live view image acquisition request is received (NO in step S702), the processing proceeds to step S704.

In step S703, the system control unit 50 transmits live view image information to the PC 310 in response to the live view image acquisition request from the PC 310, and the processing proceeds to step S704. The transmitted information includes lens optical information in addition to the live view image information.

In step S704, the system control unit 50 transmits imaging parameter information to the PC 310, and the processing proceeds to step S705. The imaging parameter information herein may include, for example, at least one of optical characteristic information about a lens and acceleration information about an external image capturing apparatus. Further, at least one of color tone, contrast, sharpness, white balance, and exposure information set in the digital camera 100 may be included.

In step S705, the system control unit 50 determines whether an image capture instruction from the PC 310 or an image capture instruction issued by the user by operating the digital camera 100 is received. Then, in a case where the system control unit 50 determines that an image capture instruction is received (YES in step S705), the processing proceeds to step S706. On the other hand, in a case where the system control unit 50 determines that no image capture instruction is received (NO in step S705), the processing proceeds to step S708.

In step S706, the system control unit 50 performs an imaging process and transmits a captured image to the PC 310, and the processing proceeds to step S707.

In step S707, the system control unit 50 receives a composite image from the PC 310, and the processing proceeds to step S708.

In step S708, the system control unit 50 stores the image received in step S707 in the recording medium 227, and the processing proceeds to step S709.

In step S709, the system control unit 50 determines whether the connection to the PC 310 is disconnected. Then, in a case where the system control unit 50 determines that the connection to the PC 310 is disconnected (YES in step S709), the process is terminated. On the other hand, in a case where the system control unit 50 determines that the connection to the PC 310 is not disconnected (NO in step S709), the processing proceeds to step S710.

In step S710, the system control unit 50 determines whether an imaging parameter change request from the PC 310 or an imaging parameter change request issued by the user by operating the digital camera 100 is received. Then, in a case where the system control unit 50 determines that an imaging parameter change request is received (YES in step S710), the processing proceeds to step S711. On the other hand, in a case where the system control unit 50 determines that no imaging parameter change request is received (NO in step S710), the processing proceeds to step S702.

In step S711, the system control unit 50 changes the imaging parameter based on the imaging parameter change request, and the processing proceeds to step S702.

### Example of Processing Flow in HMD 300

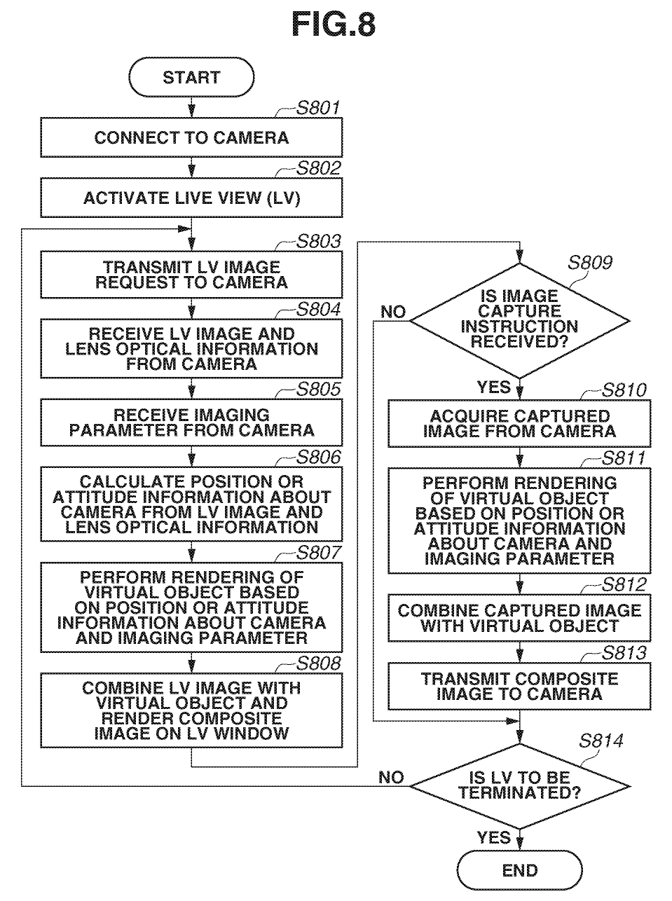

An example of a processing flow in the PC 310 according to an embodiment of the present disclosure will be described with reference to FIG. 8. In a case where the functions of the PC 310 are integrated into the HMD 300, the process is performed by the HMD 300.

The process in FIG. 8 is realized by the control unit 311 of the PC 310 by loading a program recorded in the non-volatile memory 312 onto the working memory 313 and executing the loaded program. The process in FIG. 8 is performed repeatedly, for example, at a predetermined frequency (such as 60 Hz or 120 Hz). Further, the flowchart is started in a case where an operation to connect to the digital camera 100 is performed or an instruction to activate an application for displaying a virtual window configured to display a live view image in the MR environment is issued. The flowchart is based on a case where the digital camera 100 connects to the HMD 300 via the PC 310.

In step S801, the control unit 311 controls the communication unit 314 and connects to the digital camera 100 so that the control unit 311 can communicate with the digital camera 100, and the processing proceeds to step S802. The connection method at this time is not restricted, and either wireless or wired communication may be used.

In step S802, the control unit 311 activates the application for displaying a virtual window configured to display a live view image in the MR environment, and the processing proceeds to step S803.

The activated virtual window configured to display a live view image is displayed on the image display unit 303 via the HMD control unit 301, similarly to the virtual window 510 in the screen display 600 in FIG. 6A.

In step S803, the control unit 311 transmits a live view image request to the digital camera 100, and the processing proceeds to step S804.

In step S804, the control unit 311 receives a live view image and the lens optical information from the digital camera 100, and the processing proceeds to step S805.

In step S805, the control unit 311 receives the imaging parameter information from the digital camera 100, and the processing proceeds to step S806. The imaging parameter information herein may include, for example, at least one of the optical characteristic information about the lens and the acceleration information about the external image capturing apparatus. Further, at least one of the color tone, contrast, sharpness, white balance, and exposure information set in the digital camera 100 may be included.

In step S806, the control unit 311 calculates position or attitude information about the digital camera 100 from the live view image and the lens optical information, and the processing proceeds to step S807. In the present embodiment, an example in which a method based on continuous image information, such as Simultaneous Localization and Mapping (SLAM), is used to calculate position or attitude information is described. This enables a configuration capable of calculating a position or attitude of a camera including only a standard image capture function. However, in a case where the camera includes a mechanism configured to acquire depth information, such as a Time of Flight (ToF) sensor, it is possible to employ a configuration in which the information is acquired from the camera and position or attitude information is calculated.

In step S807, the control unit 311 generates a virtual object to be combined with the live view image received in step S804 based on the position or attitude of the digital camera 100 calculated in step S806, and the processing proceeds to step S808. In other words, three-dimensional (3D) rendering processing is performed so that the virtual object has an appropriate position or attitude with respect to the position or attitude of the digital camera 100, thereby generating an image similar to the virtual object 513 in the screen display 600 in FIG. 6A, and the processing proceeds to step S808. At this time, 3D rendering may be performed using the lens optical information received from the digital camera 100 in step S804, thereby generating a more natural virtual object image to which an imaging characteristic of the digital camera 100 is applied. At this time, 3D rendering may be performed using the imaging parameter information received from the digital camera 100 in step S805, thereby generating a more natural virtual object image corresponding to the captured image generated by the digital camera 100. For example, the "hue" of the virtual object may be changed based on the "hue" of the digital camera 100. Further, for example, a blur effect may be applied to the virtual object based on the "shutter speed" and "acceleration information" of the digital camera 100. Further, for example, a depth of field of the virtual object may be changed based on the "aperture value" and "in-focus position" of the digital camera 100. Further, for example, a noise level of the virtual object may be changed based on the "ISO speed rating" of the digital camera 100. The placement of the virtual object to achieve the appropriate position or attitude described above may vary depending on the setting. The virtual object may be placed to be fixed at a specific position in the MR environment, or may be positioned to track the movement of the user. Further, in a case where an operation to move the virtual object is performed by the user, the virtual object may be placed at a position corresponding to the operation.

In step S808, the control unit 311 combines the live view image 511 on the screen display 600 in FIG. 6A with the image generated in step S807 to generate a composite image and renders the composite image on the virtual window 510, and the processing proceeds to step S809. The image rendered herein is referenced by the user 501 illustrated in FIG. 5 to check, in real time, the angle of view from which the digital camera 100 captures an MR image combining the real environment with the virtual object. Thus, the process of combining the virtual object in steps S807 and S808 can be configured to reduce the load relative to a process of combining a virtual object in steps S811 and S812, which will be described below. Possible examples thereof include reducing the quality of a 3D model to be rendered (such as the number of polygons and texture quality) and simplifying shading and reflection effects applied to the 3D model.

In step S809, the control unit 311 determines whether an image capture instruction issued by the user 501 illustrated in FIG. 5 by operating the operation member 514 on the virtual window 510 or an image capture instruction issued by operating the digital camera 100 is received. Then, in a case where the control unit 311 determines that an image capture instruction is received (YES in step S809), the processing proceeds to step S810. On the other hand, in a case where the control unit 311 determines that no image capture instruction is received (NO in step S809), the processing proceeds to step S814.

In step S810, the control unit 311 receives a captured image from the digital camera 100, and the processing proceeds to step S811.

In step S811, the control unit 311 generates a virtual object to be combined with the captured image received in step S810 based on the position or attitude of the digital camera 100 calculated in step S806, and the processing proceeds to step S812. In other words, 3D rendering processing is performed so that the virtual object has an appropriate position or attitude with respect to the position or attitude of the digital camera 100, thereby generating an image similar to the virtual object 513 in the screen display 600 in FIG. 6A, and the processing proceeds to step S812. At this time, 3D rendering may be performed using the lens optical information received from the digital camera 100 in step S804, thereby generating a more natural virtual object image to which an imaging characteristic of the digital camera 100 is applied. At this time, the imaging parameter information received from the digital camera 100 in step S805 may be taken into consideration, thereby generating a more natural virtual object image corresponding to the captured image generated by the digital camera 100, as illustrated by the virtual object 603. For example, the "hue" of the virtual object may be changed based on the "hue" of the digital camera 100. Further, for example, a blur effect may be applied to the virtual object based on the "shutter speed" and "acceleration information" of the digital camera 100 or movement information about the virtual object. Further, for example, the depth of field of the virtual object may be changed based on the "aperture value" and "in-focus position" of the digital camera 100. Further, for example, the noise level of the virtual object may be changed based on the "ISO speed rating" of the digital camera 100.

In step S812, the control unit 311 combines the captured image received from the digital camera 100 in step S810 with the virtual object generated in step S811 to generate a composite image, and the processing proceeds to step S813.

In step S813, the control unit 311 transmits the composite image generated in step S812 to the digital camera 100, and the processing proceeds to step S814.

In step S814, the control unit 311 determines whether the application for displaying a virtual window configured to display a live view image in the MR environment is to be terminated. Then, in a case where the control unit 311 determines that the live view is to be terminated (YES in step S814), the process is terminated. On the other hand, in a case where the control unit 311 determines that the live view is not to be terminated (NO in step S814), the processing proceeds to step S803.

Following the flow described above makes it possible to capture an image of a mixed reality environment while simultaneously viewing a live view image captured by an external image capturing apparatus and a virtual object and a real object as subjects.

Although the composite image is transmitted to the digital camera 100 and stored in the digital camera 100 in the present embodiment, the composite image may be stored in the HMD 300 or the PC 310.

### Modified Example

In the first embodiment described above, capturing a scene in which a virtual object appears to be present in the real environment is considered. Thus, in a case where the image capturing range of the digital camera 100 consists entirely of the virtual object, capturing an image with the digital camera 100 is less advantageous. Accordingly, in a case where the image capturing range of the digital camera 100 consists entirely of the virtual object, a notification may be provided to the user. This improves usability during image capture in a case where both a real object and a virtual object are included within the image capturing range.

Further, in a case where capturing an image while holding the digital camera 100 and checking a virtual window displayed on the HMD 300 is considered, there is a concern that the number of items to be checked increases as compared to capturing solely the real environment. Thus, a user interface (such as a virtual button) for changing an orientation of a virtual object may be provided so that the virtual object can be arranged as intended by the user after the image capturing range of the real environment is determined. For example, a button for causing the virtual object to face forward (to be oriented forward) based on the position or attitude of the HMD 300 and a button for changing the orientation of the virtual object by a predetermined angle may be provided.

Further, in the first embodiment described above, capturing an image while holding the digital camera 100 and checking a virtual window displayed on the HMD 300 is considered. In addition, an operation method for fixing a camera position using a tripod may be prepared. For example, in a case where the digital camera 100 is held by the user, an operation such as capturing an image, changing a setting, or changing the position of the virtual object may be assigned to an operation member of the camera. Further, in a case where the digital camera 100 is fixed to the tripod, placed on a desk or the like, or held by the user, a user interface may be provided to perform the above-described operations. In other words, the display of the virtual window or the user interface for operating the digital camera 100 is adjusted so that the display in a case where the digital camera 100 is held in the hand of the user is different from the display in a case where the digital camera 100 is not held in the hand of the user. Further, in a case where the digital camera 100 is held in the hand of the user, an operation from the digital camera 100 may be received, and in a case where the digital camera 100 is not held in the hand of the user, an operation from the user interface displayed on the HMD 300 may be received.

Further, an image quality of the virtual object or the live view image displayed in the virtual window may be made different between a case where wireless communication is performed with the digital camera 100 and a case where wired communication is performed with the digital camera 100. In a case where wireless communication is performed with the digital camera 100, communication volume may be restricted, compared to a case where wired communication is performed with the digital camera 100. Thus, in the case where wireless communication is performed with the digital camera 100, the image quality of the virtual object or the live view image displayed in the virtual window may be lowered to reduce the communication volume. In a case where the configuration is capable of reducing the communication volume as well as the image quality, data other than the image quality may be reduced.

The present disclosure makes it possible to improve user experience in a case where imaging is performed while viewing a virtual object placed in the real environment through an HMD.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069946, filed Apr. 21, 2025, which is hereby incorporated by reference herein in its entirety.

What is claimed is:

1. An information processing apparatus configured to be connected to, or integrated with, a display apparatus worn on a head of a user, the information processing apparatus comprising:
a processor; and
a memory storing a program which, when executed by the processor, causes the information processing apparatus to:
execute first acquisition processing to acquire a first captured image in accordance with a position or an attitude of the display apparatus, and
execute display control processing to perform control to display, on the display apparatus, a first composite image in which the first captured image and a virtual window based on a live view image from an external image capturing apparatus are combined,
wherein, in the first composite image, a virtual object displayed outside the virtual window is rendered without being based on a position or an attitude of the external image capturing apparatus and without being based on an imaging parameter of the external image capturing apparatus, and
wherein, in the first composite image, the virtual object displayed inside the virtual window is rendered based on the position or the attitude of the external image capturing apparatus and the imaging parameter.

2. The information processing apparatus according to claim 1,
wherein the program, when executed by the processor, further causes the information processing apparatus to:
execute control processing to perform control to record, in a recording unit, in a case where an image capture instruction is issued to the external image capturing apparatus, a second composite image in which an image captured by the external image capturing apparatus and the virtual object are combined, and
wherein the virtual object combined in the second composite image is rendered based on the position or the attitude of the external image capturing apparatus and the imaging parameter.

3. The information processing apparatus according to claim 1, wherein the program, when executed by the processor, further causes the information processing apparatus to execute second acquisition processing to acquire the imaging parameter set in the external image capturing apparatus.

4. The information processing apparatus according to claim 1, wherein, in the virtual window, the live view image and the virtual object are displayed with the imaging parameter of the external image capturing apparatus applied thereto.

5. The information processing apparatus according to claim 1, wherein the imaging parameter includes at least one of optical characteristic information about a lens and acceleration information about the external image capturing apparatus.

6. The information processing apparatus according to claim 1,
wherein the program, when executed by the processor, further causes the information processing apparatus to execute third acquisition processing to acquire the position or the attitude of the external image capturing apparatus, and
wherein the virtual object displayed in the virtual window is rendered in an orientation based on the position or the attitude of the external image capturing apparatus.

7. The information processing apparatus according to claim 1, wherein an image quality of the virtual object or the live view image displayed in the virtual window is made different between a case where wireless communication is performed with the external image capturing apparatus and a case where wired communication is performed with the external image capturing apparatus.

8. The information processing apparatus according to claim 1, wherein, in the display control processing, control is performed to apply a blur effect to the virtual object displayed in the virtual window based on movement information about the virtual object or the imaging parameter of the external image capturing apparatus.

9. The information processing apparatus according to claim 1, wherein, in the display control processing, control is performed to change display of the virtual object in accordance with at least one of color tone, contrast, sharpness, white balance, and exposure information set in the external image capturing apparatus.

10. The information processing apparatus according to claim 1, wherein the program, when executed by the processor, further causes the information processing apparatus to execute notification processing to provide a notification in a case where there is no region other than the virtual object in an image capturing range of the external image capturing apparatus.

11. The information processing apparatus according to claim 1, wherein, in the display control processing, a user interface for arranging the virtual object such that the virtual object faces the external image capturing apparatus is displayed together with the virtual window.

12. The information processing apparatus according to claim 1, wherein, in the display control processing, display of the virtual window or a user interface used to operate the external image capturing apparatus is made different between a case where the external image capturing apparatus is held in a hand of the user and a case where the external image capturing apparatus is not held in the hand of the user.

13. The information processing apparatus according to claim 1,
wherein the program, when executed by the processor, further causes the information processing apparatus to execute reception processing to receive an operation performed on the external image capturing apparatus, and
wherein in the reception processing, in a case where the external image capturing apparatus is held in a hand of the user, an operation from the external image capturing apparatus is received, and in a case where the external image capturing apparatus is not held in the hand of the user, an operation from a user interface displayed on the display apparatus is received.

14. A method for controlling an information processing apparatus configured to be connected to, or integrated with, a display apparatus worn on a head of a user, the method comprising:
acquiring a first captured image in accordance with a position or an attitude of the display apparatus; and
performing control to display, on the display apparatus, a first composite image in which the first captured image and a virtual window based on a live view image from an external image capturing apparatus are combined,
wherein, in the first composite image, a virtual object displayed outside the virtual window is rendered without being based on a position or an attitude of the external image capturing apparatus and without being based on an imaging parameter of the external image capturing apparatus, and
wherein, in the first composite image, the virtual object displayed inside the virtual window is rendered based on the position or the attitude of the external image capturing apparatus and the imaging parameter.

15. A non-transitory computer readable medium that stores a program, wherein the program causes a computer to execute a method for controlling an information processing apparatus according to claim 14.

16. A system comprising:
a display apparatus;
a first acquisition apparatus configured to acquire a first captured image in accordance with a position or an attitude of the display apparatus;
an external image capturing apparatus configured to acquire an image different from the first captured image; and
a display control apparatus configured to perform control to display, on the display apparatus, a first composite image in which the first captured image and a virtual window based on a live view image from the external image capturing apparatus are combined,
wherein, in the first composite image, a virtual object displayed outside the virtual window is rendered without being based on a position or an attitude of the external image capturing apparatus and without being based on an imaging parameter of the external image capturing apparatus, and
wherein, in the first composite image, the virtual object displayed inside the virtual window is rendered based on the position or the attitude of the external image capturing apparatus and the imaging parameter.
